(19) United States
(12) Patent Application Publication
(10) Pub. No.: US 2024/0193011 A1
(43) Pub. Date: Jun. 13, 2024

(54) PROCESS COMMUNICATION METHODS AND APPARATUSES

(71) Applicants: Chongqing BOE Intelligent Technology Co., Ltd., Chongqing (CN); BOE Technology Group Co., Ltd., Beijing (CN)

(72) Inventor: Dong HONG, Beijing (CN)

(21) Appl. No.: 18/284,704

(22) PCT Filed: Dec. 31, 2021
(86) PCT No.: PCT/CN2021/143928

§ 371 Date: Sep. 28, 2023

(51) Int. Cl. G06F 9/54

(52) U.S. Cl. CPC G06F 9/54

(57) ABSTRACT

The present disclosure provides a process communication method and apparatus. The method includes: determining a second process corresponding to to-be-processed data, where a first process and the second process are implemented based on a cross-platform application development framework; and when the second process is not on a first processing node, according to a first communication manner, send the to-be-processed data to the second process to enable the second process to accordingly process the to-be-processed data, where a first communication manner indicates a communication manner between non-local processes, which achieves successful communication between processes based on a cross-platform application development framework, and ensures the reliability of process communication.

### TECHNICAL FIELD

The present disclosure relates to the field of communication technology, in particular to process communication methods and apparatuses.

### BACKGROUND

Qt is a cross-platform C++ graphical-user-interface application development framework. Qt is widely used to develop graphical user interface (GUI) programs and non-GUI programs (for example, console tools and servers).

At present, during an operation of a Qt program, a process corresponding to the Qt program, namely a Qt process, usually need to communicate with processes corresponding to other Qt programs. During communications between Qt processes, a preset single communication method is generally used as the current communication method to utilize the communication method for communication.

However, since communication can only be performed based on a preset single communication method, the communication method is single, and when the communication method is not set properly, it will cause the Qt processes to be unable to successfully communicate with each other, and the communication reliability is low.

### SUMMARY

In view of this, one of purposes of the present disclosure is to provide process communication methods and apparatuses.

According to the first aspect of the embodiments of the present disclosure, a process communication method is provided, and applied to a first processing node to perform data processing through at least one first process, and includes:
determining a second process corresponding to to-be-processed data, where the first process and the second process are implemented based on a cross-platform application development framework; and
in a case where the second process is not on the first processing node, according to a first communication manner, sending the to-be-processed data to the second process to enable the second process to accordingly process the to-be-processed data, where the first communication manner indicates a communication manner between non-local processes.

In some embodiments, according to the first communication manner, sending the to-be-processed data to the second process includes:
determining a first target proxy thread, where the first target proxy thread is configured to serve as a proxy for a communication service between the first process and the second process; and
sending the to-be-processed data to the first target proxy thread, to enable the first target proxy thread to send the to-be-processed data to the second process.

In some embodiments, the first target proxy thread is a proxy thread corresponding to the second process, and is created in a case that a connection between the second process and the first process is established, where the first target proxy thread indicates a first socket corresponding to the second process; and
sending the to-be-processed data to the first target proxy thread, to enable the first target proxy thread to send the to-be-processed data to the second process includes:
sending the to-be-processed data to a proxy thread corresponding to the second process, to enable the proxy thread corresponding to the second process to send the to-be-processed data to the second process based on the first socket.

In some embodiments, the method further includes:
starting a transmission control protocol (TCP) service, and in a case where the second process connects to the TCP service, creating a first socket corresponding to the second process; or in response to receiving a protocol Websocket connection request for full duplex communication sent by the second process, creating a first socket corresponding to the second process; and
based on the first socket, creating a proxy thread corresponding to the second process.

In some embodiments, the first communication manner includes a user datagram protocol (UDP) communication manner, the first target proxy thread is a universal proxy thread corresponding to the UDP communication manner, the universal proxy thread is configured to serve as a proxy for a data transmission service when the first process communicates with other processes based on the UDP communication manner, the UDP communication manner indicates a second socket, and the second socket is configured to send data;
sending the to-be-processed data to the first target proxy thread, to enable the first target proxy thread to send the to-be-processed data to the second process includes:
sending the to-be-processed data to the universal proxy thread, to enable the universal proxy thread to send the to-be-processed data to the second process based on the second socket.

In some embodiments, the UDP communication manner further indicates a third socket, where the third socket is configured to receive data; and
the method further includes:
based on the third socket, receiving first data sent by other processes.

In some embodiments, according to the first communication manner, sending the to-be-processed data to the second process includes:
in response to determining that a target message queue is not full, obtaining a production function address; and
based on the production function address, calling a corresponding production function to write the to-be-processed data to the target message queue, enabling the second process to read the to-be-processed data from the target message queue, where the production function indicates a write operation on the to-be-processed data.

In some embodiments, the method further includes:
locking the target message queue.

According to the second aspect of the embodiments of the present disclosure, a process communication method is provided, and applied to a first processing node to perform data processing through at least one first process, and includes:
determining a second process corresponding to to-be-processed data, where the first process and the second process are implemented based on a cross-platform application development framework; and
in a case where the second process is on the first processing node, according to a second communication manner, sending the to-be-processed data to the second process to enable the second process to accordingly process the to-be-processed data, where the second communication manner indicates a communication manner between local processes.

In some embodiments, according to the second communication manner, sending the to-be-processed data to the second process includes:
obtaining a handle of a target communication object, and based on the handle of the target communication object, sending the to-be-processed data to the second process.

In some embodiments, the second communication manner includes anonymous-pipe communication manner, and the target communication object includes a first pipe indicated by the anonymous-pipe communication manner, where the first pipe is configured for data writing, and the first process and the second process are parent-child processes;
based on the handle of the target communication object, sending the to-be-processed data to the second process includes:
determining a proxy thread corresponding to the first pipe, where the proxy thread corresponding to the first pipe is configured to serve as a proxy for a data writing service corresponding to the first pipe; and
sending the to-be-processed data to the proxy thread corresponding to the first pipe, to enable the proxy thread corresponding to the first pipe to write the to-be-processed data to the first pipe based on the handle of the first pipe, enabling the second process to read the to-be-processed data from the first pipe.

In some embodiments, the anonymous-pipe communication manner further indicates a second pipe, where the second pipe is configured for data reading;
the method further includes:
receiving second data sent by a proxy thread corresponding to the second pipe, where the second data is data that is written by other processes and read from the second pipe based on a handle of the second pipe by the proxy thread corresponding to the second pipe; and the proxy thread corresponding to the second pipe is configured to serve as a proxy for a data reading service corresponding to the second pipe.

In some embodiments, the target communication object includes a form of the second process;
based on the handle of the target communication object, sending the to-be-processed data to the second process includes:
obtaining a form name of the second process, and determining a form handle of the second process corresponding to the form name; and
based on the form handle, sending the to-be-processed data to the form of the second process.

In some embodiments, according to the second communication manner, sending the to-be-processed data to the second process includes:
obtaining a local socket corresponding to the second process, where the local socket corresponding to the second process is created when a pipe connection request sent by the second process is received; and
based on the local socket corresponding to the second process, writing the to-be-processed data to a pipe corresponding to the local socket corresponding to the second process, to enable the second process to read the to-be-processed data from a pipe corresponding to the local socket corresponding to the second process.

In some embodiments, according to the second communication manner, sending the to-be-processed data to the second process includes:
writing the to-be-processed data to a target data bus to enable a data bus service corresponding to the target data bus to determine a response function bound to the to-be-processed data; and when the second process is bound to the response function, sending the to-be-processed data to the second process.

In some embodiments, according to the second communication manner, sending the to-be-processed data to the second process includes:
determining an idle shared-memory region; and
locking the idle shared-memory region, writing the to-be-processed data into the idle shared-memory region, and unlocking the idle shared-memory region, to enable the second process to read the to-be-processed data from the idle shared-memory region.

According to the third aspect of the embodiments of the present disclosure, a process communication method is provided, and applied to a second processing node to perform data processing through at least one second process, and includes:
receiving to-be-processed data sent by a first process, where the to-be-processed data is sent by the first process based on a first communication manner or a second communication manner; and
performing corresponding processing on the to-be-processed data.

In some embodiments, the method further includes:
in the case where the to-be-processed data is bound to a preset slot function, based on the preset slot function, performing corresponding processing on the to-be-processed data.

In some embodiments, receiving the to-be-processed data sent by the first process includes:
obtaining a consumption function address; and
based on the consumption function address, calling a corresponding consumption function to read the to-be-processed data from a target message queue, where the consumption function indicates a read operation on the to-be-processed data.

In some embodiments, the method further includes:
locking the target message queue; and
in response to determining that the target message queue is not empty, obtaining the consumption function address.

According to the fourth aspect of the embodiments of the present disclosure, a process communication apparatus is provided, and applied to a first processing node to perform data processing through at least one first process, and includes:
a first process determination module, configured to determine a second process corresponding to to-be-processed data, where the first process and the second process are implemented based on a cross-platform application development framework; and
a first communication module, configured to, in a case where the second process is not on the first processing node, according to a first communication manner, send the to-be-processed data to the second process to enable the second process to accordingly process the to-be-processed data, where the first communication manner indicates a communication manner between non-local processes.

In some embodiments, the first communication module is configured to:
determine a first target proxy thread, where the first target proxy thread is configured to serve as a proxy for a communication service between the first process and the second process; and
send the to-be-processed data to the first target proxy thread, to enable the first target proxy thread to send the to-be-processed data to the second process.

In some embodiments, the first target proxy thread is a proxy thread corresponding to the second process, and is created in a case that a connection between the second process and the first process is established, where the first target proxy thread indicates a first socket corresponding to the second process; and
the first communication module is further configured to:
send the to-be-processed data to a proxy thread corresponding to the second process, to enable the proxy thread corresponding to the second process to send the to-be-processed data to the second process based on the first socket.

In some embodiments, the first communication module is further configured to:
start a transmission control protocol (TCP) service, and in a case where the second process connects to the TCP service, create a first socket corresponding to the second process; or in response to receiving a protocol Websocket connection request for full duplex communication sent by the second process, create a first socket corresponding to the second process; and
based on the first socket, create a proxy thread corresponding to the second process.

In some embodiments, the first communication manner includes a user datagram protocol (UDP) communication manner, the first target proxy thread is a universal proxy thread corresponding to the UDP communication manner, the universal proxy thread is configured to serve as a proxy for a data transmission service when the first process communicates with other processes based on the UDP communication manner, the UDP communication manner indicates a second socket, and the second socket is configured to send data;
the first communication module is configured to:
send the to-be-processed data to the universal proxy thread, to enable the universal proxy thread to send the to-be-processed data to the second process based on the second socket.

In some embodiments, the UDP communication manner further indicates a third socket, where the third socket is configured to receive data; and
the first communication module is further configured to:
based on the third socket, receive first data sent by other processes.

In some embodiments, the first communication module is configured to:
in response to determining that a target message queue is not full, obtain a production function address; and
based on the production function address, call a corresponding production function to write the to-be-processed data to the target message queue, enabling the second process to read the to-be-processed data from the target message queue, where the production function indicates a write operation on the to-be-processed data.

In some embodiments, the first communication module is further configured to:
lock the target message queue.

According to the fifth aspect of the embodiments of the present disclosure, a process communication apparatus is provided, and applied to a first processing node to perform data processing through at least one first process, and includes:
a second process determination module, configured to determine a second process corresponding to to-be-processed data, where the first process and the second process are implemented based on a cross-platform application development framework; and
a second communication module, configured to, in a case where the second process is on the first processing node, according to a second communication manner, send the to-be-processed data to the second process to enable the second process to accordingly process the to-be-processed data, where the second communication manner indicates a communication manner between local processes.

In some embodiments, the second communication module is configured to:
obtain a handle of a target communication object, and based on the handle of the target communication object, send the to-be-processed data to the second process.

In some embodiments, the second communication manner includes anonymous-pipe communication manner, and the target communication object includes a first pipe indicated by the anonymous-pipe communication manner, where the first pipe is configured for data writing, and the first process and the second process are parent-child processes;
the second communication module is further configured to:
determine a proxy thread corresponding to the first pipe, where the proxy thread corresponding to the first pipe is configured to serve as a proxy for a data writing service corresponding to the first pipe; and
send the to-be-processed data to the proxy thread corresponding to the first pipe, to enable the proxy thread corresponding to the first pipe to write the to-be-processed data to the first pipe based on the handle of the first pipe, enabling the second process to read the to-be-processed data from the first pipe.

In some embodiments, the anonymous-pipe communication manner further indicates a second pipe, where the second pipe is configured for data reading;
the second communication module is further configured to:
receive second data sent by a proxy thread corresponding to the second pipe, where the second data is data that is written by other processes and read from the second pipe based on a handle of the second pipe by the proxy thread corresponding to the second pipe; and the proxy thread corresponding to the second pipe is configured to serve as a proxy for a data reading service corresponding to the second pipe.

In some embodiments, the target communication object includes a form of the second process;
the second communication module is further configured to:
obtain a form name of the second process, and determine a form handle of the second process corresponding to the form name; and
based on the form handle, send the to-be-processed data to the form of the second process.

In some embodiments, the second communication module is configured to:
obtain a local socket corresponding to the second process, where the local socket corresponding to the second process is created when the second process is connected to a named pipe created by the first process; and
based on the local socket corresponding to the second process, send the to-be-processed data to the second process.

In some embodiments, the second communication module is configured to:
write the to-be-processed data to a target data bus to enable a data bus service corresponding to the target data bus to determine a response function bound to the to-be-processed data; and when the second process is bound to the response function, send the to-be-processed data to the second process.

In some embodiments, the second communication module is configured to:
determine an idle shared-memory region; and
lock the idle shared-memory region, writing the to-be-processed data into the idle shared-memory region, and unlock the idle shared-memory region, to enable the second process to read the to-be-processed data from the idle shared-memory region.

According to the sixth aspect of the embodiments of the present disclosure, a process communication apparatus is provided, and applied to a second processing node to perform data processing through at least one second process, and includes:
a data acquisition module, configured to receive to-be-processed data sent by a first process, where the to-be-processed data is sent by the first process based on a first communication manner or a second communication manner; and
a data processing module, configured to perform corresponding processing on the to-be-processed data.

In some embodiments, the data processing module is configured to:
in the case where the to-be-processed data is bound to a preset slot function, based on the preset slot function, perform corresponding processing on the to-be-processed data.

In some embodiments, the data acquisition module is configured to:
obtain a consumption function address; and
based on the consumption function address, call a corresponding consumption function to read the to-be-processed data from a target message queue, where the consumption function indicates a read operation on the to-be-processed data.

In some embodiments, the data acquisition module is further configured to:
lock the target message queue; and
in response to determining that the target message queue is not empty, obtaining the consumption function address.

According to the seventh aspect of the embodiments of the present disclosure, a non-transitory computer-readable storage medium is provided, where a computer program is stored in the non-transitory computer-readable storage medium, and the program when executed by a processor achieves steps of the process communication method according to any one of the embodiments mentioned in the first aspect.

According to the eighth aspect of the embodiments of the present disclosure, a non-transitory computer-readable storage medium is provided, where a computer program is stored in the non-transitory computer-readable storage medium, and the program when executed by a processor achieves steps of the process communication method according to any one of the embodiments mentioned in the second aspect.

According to the ninth aspect of the embodiments of the present disclosure, a non-transitory computer-readable storage medium is provided, where a computer program is stored in the non-transitory computer-readable storage medium, and the program when executed by a processor achieves steps of the process communication method according to any one of the embodiments mentioned in the third aspect.

According to the tenth aspect of the embodiments of the present disclosure, a process communication apparatus is provided, and includes:
one or more processors;
one or more memories, configured to store processor-executable instructions;
where the one or more processors are configured to:
determine a second process corresponding to to-be-processed data, where the first process and the second process are implemented based on a cross-platform application development framework; and
in a case where the second process is not on the first processing node, according to a first communication manner, send the to-be-processed data to the second process to enable the second process to accordingly process the to-be-processed data, where the first communication manner indicates a communication manner between non-local processes.

According to the eleventh aspect of the embodiments of the present disclosure, a process communication apparatus is provided, and includes:
one or more processors;
one or more memories, configured to store processor-executable instructions;
where the one or more processors are configured to:
determine a second process corresponding to to-be-processed data, where the first process and the second process are implemented based on a cross-platform application development framework; and
in a case where the second process is on the first processing node, according to a second communication manner, send the to-be-processed data to the second process to enable the second process to accordingly process the to-be-processed data, where the second communication manner indicates a communication manner between local processes.

According to the twelfth aspect of the embodiments of the present disclosure, a process communication apparatus is provided, and includes:
one or more processors;
one or more memories, configured to store processor-executable instructions;
where the one or more processors are configured to:
receive to-be-processed data sent by a first process, where the to-be-processed data is sent by the first process based on a first communication manner or a second communication manner; and
perform corresponding processing on the to-be-processed data.

According to the thirteenth aspect of the embodiments of the present disclosure, a computer program product is provided, and includes a computer program, where the computer program when executed by a processor achieves steps of the process communication method according to any one of the embodiments mentioned in the first aspect.

According to the fourteenth aspect of the embodiments of the present disclosure, a computer program product is provided, and includes a computer program, where the computer program when executed by a processor achieves steps of the process communication method according to any one of the embodiments mentioned in the second aspect.

According to the fifteenth aspect of the embodiments of the present disclosure, a computer program product is provided, and includes a computer program, where the computer program when executed by a processor achieves steps of the process communication method according to any one of the embodiments mentioned in the third aspect.

Technical solutions provided in the embodiments of the present disclosure may include following beneficial effects. It is determined whether the second process that needs to receive the to-be-processed data is on the first processing node, that is, whether the second process and the first process are in the same computer, where the first process and the second process are both implemented based on a cross-platform application development framework, and in a case where the second process is not on the first processing node, it indicates that the second process and the first process are not in the same computer, indicating that the second process is not a local process, therefore, an appropriate first communication manner can be selected to send the to-be-processed data to the second process, so that the second process can successfully receive the to-be-processed data, which achieves successful communication between non-local processes, and ensures communication reliability between processes. In a case where the second process is on a first processing node, it indicates that the second process is in the same computer as the first process, indicating that the second process is a local process, therefore, the to-be-processed data is sent to the second process based on the second communication manner, so that the second process can successfully receive the to-be-processed data, which achieves successful communication between local processes. In the present disclosure, based on the type of the second process, that is, whether the second process is a local process, a suitable communication manner is selected, where the communication methods are diverse, which ensures successful communication between processes based on the cross-platform application development framework, thereby ensuring the normal operation of the processes and improving communication reliability.

### BRIEF DESCRIPTION OF DRAWINGS

In order to more clearly illustrate the technical solutions according to the embodiments of the present disclosure, drawings that need to be used in the description of the embodiments will be briefly introduced below. The drawings in the following description only relate to some embodiments of the present disclosure. For those skilled in the art, other drawings can also be obtained based on these drawings without creative effort.

FIG. 1 is a scenario diagram of a process communication method according to an embodiment of the present disclosure.

FIG. 2 is a flowchart of a process communication method according to an embodiment of the present disclosure.

FIG. 3 is a flowchart of a process communication method according to an embodiment of the present disclosure.

FIG. 4 is a block diagram of a TCP communication manner according to an embodiment of the present disclosure.

FIG. 5 is a block diagram of a Websocket communication manner according to an embodiment of the present disclosure.

FIG. 6 is a block diagram of a UDP communication manner according to an embodiment of the present disclosure.

FIG. 7 is a block diagram of a message-queue communication manner according to an embodiment of the present disclosure.

FIG. 8 is a flowchart of a process communication method according to an embodiment of the present disclosure.

FIG. 9 is a block diagram of an anonymous-pipe communication manner according to an embodiment of the present disclosure.

FIG. 10 is a block diagram of a form communication manner according to an embodiment of the present disclosure.

FIG. 11 is a block diagram of a named-pipe communication manner according to an embodiment of the present disclosure.

FIG. 12 is a block diagram of a data-bus communication manner according to an embodiment of the present disclosure.

FIG. 13 is a block diagram of a shared-memory communication manner according to an embodiment of the present disclosure.

FIG. 14 is a flowchart of a process communication method according to an embodiment of the present disclosure.

FIG. 15 is a hardware structure diagram of a computer device where a process communication apparatus of the present disclosure is located.

FIG. 16 is a block diagram of a process communication apparatus according to an embodiment of the present disclosure.

FIG. 17 is a block diagram of a process communication apparatus according to an embodiment of the present disclosure.

FIG. 18 is a block diagram of a process communication apparatus according to an embodiment of the present disclosure.

### DETAILED DESCRIPTION

The technical solutions in the embodiments of the present disclosure are clearly described below with reference to the accompanying drawings in the embodiments of the present disclosure. The embodiments described are merely some embodiments of the present disclosure, and not all embodiments. Other embodiments achieved by those of ordinary skill in the art based on the embodiments in the present disclosure without paying creative work shall all fall within the scope of protection of the present disclosure.

For ease of understanding, terms involved in the present disclosure are first explained below.

Signal-slot mechanism: Signal slot is one of mechanisms of Qt framework. The signal slot is actually an Observer mode. After an event occurs, for example, when a button detects that the button is clicked, the button emits a signal, which is similar to a broadcast signal. If an object is interested in the signal, the object can use a connect function, that is, the object can band a to-be-processed signal to a function (i.e., a slot function) process of the object to process the signal. Correspondingly, when the signal is emitted, the connected slot function will automatically be called back.

Meta-object system of Qt: Meta-object system of Qt is based on following three things of: 1) a class (i.e., QObject), where a class provides a base class for all objects that need to utilize the Meta-object system; 2) a macro (i.e. Q_OBJECT), where a macro can usually be declared in a private segment of a class, so that the class can use characteristics of Meta-object, such as dynamic properties, signals and slots; and 3) a compiler, where a Meta-object compiler (moc) automatically generates a necessary code for each QObject sub-object to implement characteristics of the Meta-object.

A detailed explanation of the embodiments of this specification is provided blow.

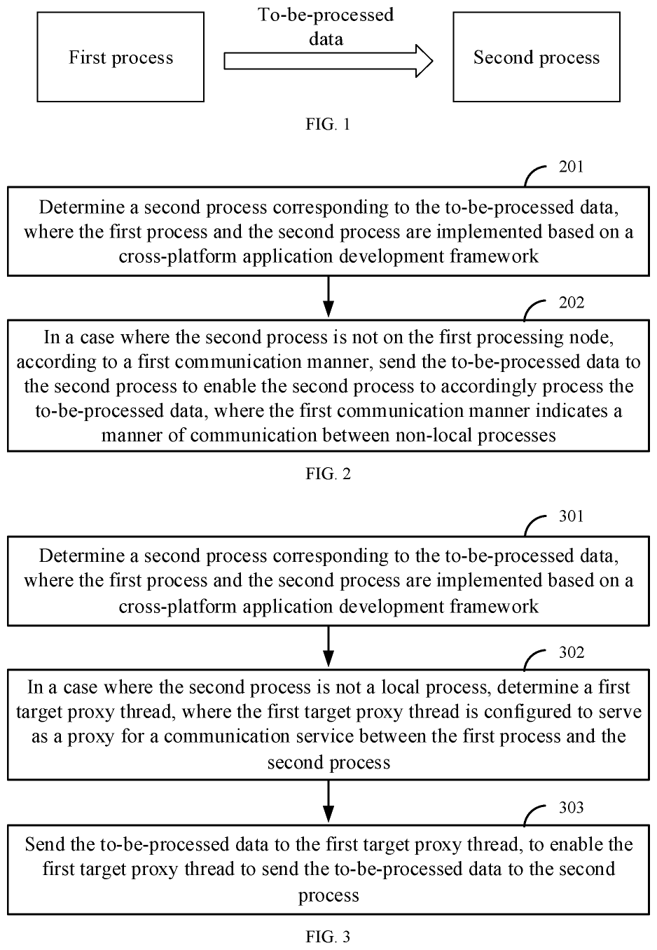

As shown in FIG. 1, a scenario diagram of a process communication method according to an embodiment of the present disclosure, when a first process 101 communicates with a second process 102, a corresponding communication manner is determined based on an actual situation of the first process 101 and the second process 102, such that data transmission can be performed using the communication manner.

A first process 101 and the second process 102 are both Qt processes, i.e., processes implemented based on Qt.

The first process is on a first processing node, that is, the first processing node processes data through at least one first process. A second process is on a second processing node, that is, the second processing node processes data through at least one second process.

In some embodiments, the second processing node and the first processing node can be the same processing node or different processing nodes, which is not limited in the present disclosure.

A processing node can be a device such as a computer or a server.

As shown in FIG. 2, a flowchart of a process communication method according to an embodiment of the present disclosure, the method is applied to a first processing node, where the first processing node includes at least one first process. The method includes the following steps S201 and S202.

In step S201, a second process corresponding to the to-be-processed data is determined. The first process and the second process are implemented based on a cross-platform application development framework.

In step S202, in a case where the second process is not on the first processing node, according to a first communication manner, the to-be-processed data is sent to the second process to enable the second process to accordingly process the to-be-processed data. The first communication manner indicates a manner of communication between non-local processes.

In this embodiment, when the first process needs to send data, the data is taken as to-be-processed data, and the second process that needs to obtain the to-be-processed data is determined. It is determined whether the second process is on the first processing node, that is, whether the second process is a local process, i.e., whether the first process and the second process are in the same computer, so as to use the determined result to select an appropriate communication manner.

The first process and the second process are implemented based on a cross-platform application development framework.

In some embodiment, the cross-platform application development framework includes Qt. Correspondingly, the first process and the second process are Qt processes, which are processes implemented based on Qt.

In a case where the second process is not on the first processing node, it indicates that the second process is not a local process, indicating that the first process and the second process are not in the same computer, indicating that communication between processes needs to be performed above a network layer, therefore, based on the first process and the second process, the first communication manner is selected as a communication manner between the first process and the second process, that is, based on a communication manner between non-local processes, the to-be-processed data is sent to the second process, so that the processes implemented based on the cross-platform application development framework in different computers can communicate, and a communication manner can be accurately selected.

In some embodiments, the first communication manner can be implemented based on a cross-platform application development framework, which is suitable for communication between Qt processes, supports all C and CPP platforms, and has good cross-platform characteristics.

In some embodiments, the first communication manner includes multi-thread communication manner and/or message-queue communication manner.

The multi-thread communication manner includes connection communication manner and/or UDP (User Datagram Protocol) communication manner.

In some embodiments, when the first communication manner is selected based on the first process and the second process, a first communication type is determined based on the first process and the second process. In a case where the first communication type is the connection communication type, a connection communication manner is used as the first communication manner; and/or, in a case where the first communication type is a connectionless communication type, a UDP communication manner is used as the first communication manner; and/or, in a case where the first communication type is queue-based communication type, a message-queue communication manner is used as the first communication manner.

In some embodiments, when the first communication type is determined based on the first process and the second process, an identifier of the first process and an identifier of the second process are obtained. A process communication type corresponding to the identifier of the first process and the identifier of the second process is determined (i.e., found) from a preset non-local process type mapping table and used as the first communication type.

For example, an identifier of a process can be determined based on the application program to which the process belongs or the node where the process is located. For example, the identifier of the first process is the identifier (such as the name) of the application program to which the first process belongs, and the identifier can also be pre-assigned, that is, identifiers corresponding to the application program to which the first processes belong are a certain identifier.

From the above description, it is determined whether the second process that needs to receive the to-be-processed data is on the first processing node, that is, whether the second process and the first process are in the same computer, where the first process and the second process are both implemented based on a cross-platform application development framework, and in a case where the second process is not on the first processing node, it indicates that the second process and the first process are not in the same computer, indicating that the second process is not a local process, therefore, an appropriate first communication manner can be selected to send the to-be-processed data to the second process, so that the second process can successfully receive the to-be-processed data, which achieves successful communication between non-local processes, and ensures communication reliability between processes. In a case where the second process is on a first processing node, it indicates that the second process is in the same computer as the first process, indicating that the second process is a local process, therefore, the to-be-processed data is sent to the second process based on the second communication manner, so that the second process can successfully receive the to-be-processed data, which achieves successful communication between local processes. In the present disclosure, based on the type of the second process, that is, whether the second process is a local process, a suitable communication manner is selected, where the communication methods are diverse, which ensures successful communication between processes based on the cross-platform application development framework, thereby ensuring the normal operation of the processes and improving communication reliability.

As shown in FIG. 3, FIG. 3 is a flowchart of a process communication method according to an embodiment of the present disclosure, when non-local processes communicate, multi-thread mechanism can be utilized for communication. As shown in FIG. 3, the method includes following steps S301 to S303.

In step S301, a second process corresponding to the to-be-processed data is determined. The first process and the second process are implemented based on a cross-platform application development framework.

In step S302, in a case where the second process is not a local process, a first target proxy thread is determined. The first target proxy thread is configured to serve as a proxy for a communication service between the first process and the second process.

In step S303, the to-be-processed data is sent to the first target proxy thread, to enable the first target proxy thread to send the to-be-processed data to the second process.

In this embodiment, the first process communicates with the second process based on multi-thread communication, that is, by using a relevant proxy thread, i.e., the first target proxy thread serves as a proxy for the communication service between the first process and the second process, which reduces the operations that need to be implemented by the first process and improves the performance during the communication service.

For example, the first process sends the to-be-processed data to the first target proxy thread. After receiving the to-be-processed data, the first target proxy thread performs related operations (such as calling related functions to process the to-be-processed data, and sending the processed data or calling a sending function to send the to-be-processed data) to send the to-be-processed data to the second process, instead of using a relevant thread (such as a main thread) in the first process for data transmission.

In some embodiment, the multi-thread communication manner includes a connection communication manner and/or a UDP communication manner.

The connection communication manner includes a TCP (Transmission Control Protocol) communication manner and/or Websocket (Full Duplex Communication Protocol) communication manner.

In some embodiments, when communications are performed based on the connection communication manner, the first process needs to establish a connection when communicating with other processes, so that a corresponding proxy thread can be created for each connection. Correspondingly, when the first process communicates with the second process, the first target proxy thread is a proxy thread corresponding to the second process, and is created when a connection between the second process and the first process is established. Since it requires a corresponding socket during communications based on the connection, the first target proxy thread indicates a first socket corresponding to the second process, that is, the second process can use the first socket to communicate with the first process.

For example, when the connection communication manner is a TCP communication manner, that is, when the first process and the second process communicate based on TCP, the first process starts the transmission control protocol (TCP) service, and the first socket corresponding to the second process is created when the second process connects to the TCP service. Based on the first socket, a proxy thread corresponding to the second process is created.

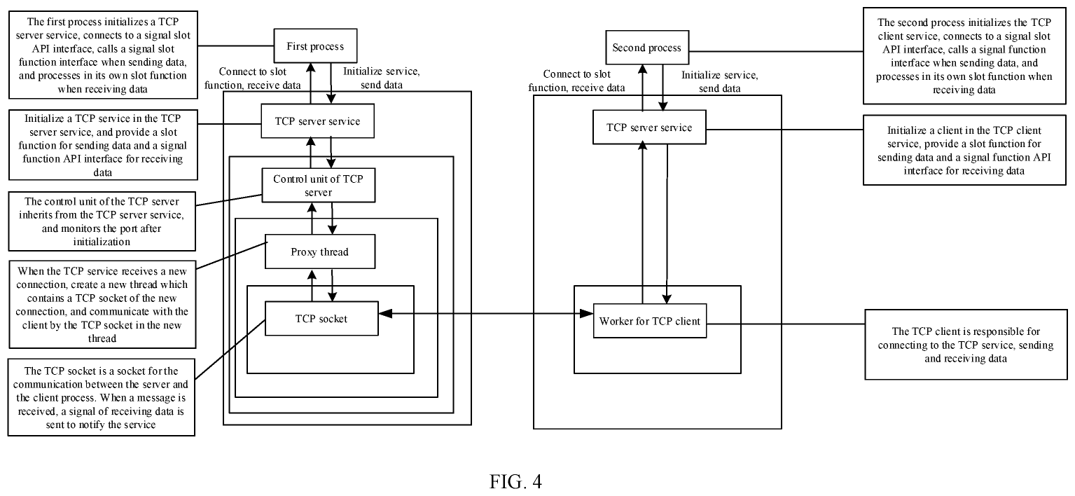

For example, as shown in FIG. 4, the first process starts the TCP service, and a process that needs to communicate with the first process needs to connect to the TCP service of the first process, that is, a program needs to connect to the TCP service of the first process. When the second process communicates with the first process through TCP, the second process connects to the TCP service of the first process. When the first process detects the TCP connection, that is, when receiving a new connection, a proxy thread to serve as a proxy for the communication service corresponding to the new connection is created, to obtain the proxy thread corresponding to the second process, and the proxy thread corresponding to the second process contains a socket (i.e., TCP socket) corresponding to the new connection.

Correspondingly, when communications are performed based on the TCP communication manner, when the second process connects to the TCP service, a socket corresponding to the connection is also created to obtain a fourth socket, and a proxy thread corresponding to the connection is created. The proxy thread is configured to serve as a proxy for related business during communications with the first process, that is, the proxy thread can receive the to-be-processed data through the fourth socket.

The proxy thread corresponding to the second process sends the to-be-processed data to the second process based on the first socket, that is, the proxy thread corresponding to the second process sends the to-be-processed data to the second process through the first socket.

In some embodiments, as shown in FIG. 4, when the first process sends data, the proxy thread corresponding to the second process can call the relevant sending function, i.e., the slot function used to send data, to process and send the to-be-processed data.

In some embodiments, as shown in FIG. 4, the first process or a related proxy thread can use a slot function for callback processing when receiving data sent by other processes.

In some embodiments, as shown in FIG. 4, the proxy thread corresponding to the second process can further monitor the first socket to receive data in time.

In this embodiment, since the TCP communication manner is based on strong TCP connections such as three handshakes and four waves, the delivery of data can be effectively ensured, and data reception and transmission can be performed through the network layer, and multiple connections can be supported. The process that needs to communicate with the first process can use a TCP socket to connect to the TCP service started by the first process, but the communication efficiency is low. Therefore, when the requirements for communication reliability are relatively high and the requirements for communication efficiency are relatively low, the TCP communication manner can be used for the communication between processes.

For example, when the connection communication manner is the Websocket communication manner, that is, when the first process and the second process communicate based on Websocket, when the full-duplex communication protocol Websocket connection request sent by the second process is received, the first socket corresponding to the second process is created. Based on the first socket, a proxy thread corresponding to the second process is created.

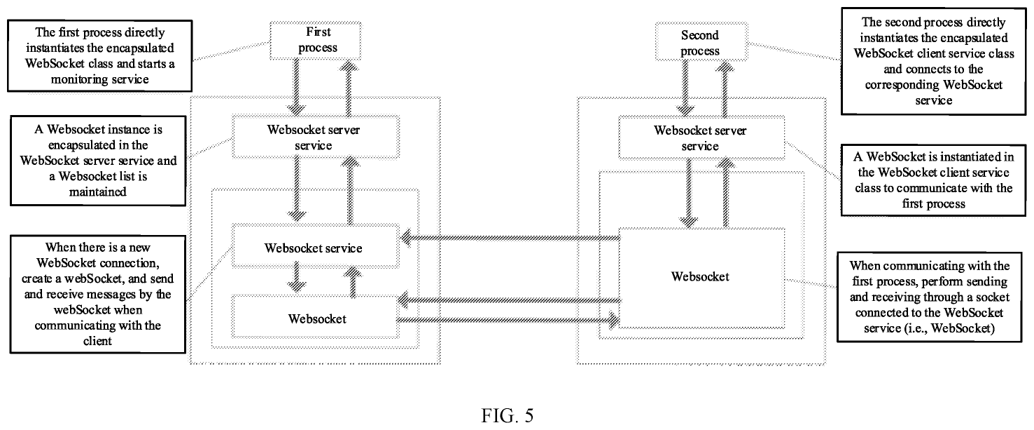

For example, as shown in FIG. 5, when a Websocket connection sent by the second process is received, that is, when a new Websocket connection is detected, a socket (i.e., websocket) corresponding to the new Websocket connection is created to obtain the first socket corresponding to the second process for sending and receiving data by using the first socket. In order to improve data processing performance, a multi-thread proxy communication service can further be utilized, that is, a proxy thread corresponding to the new Websocket connection is created and used as the proxy thread corresponding to the second process. The proxy thread corresponding to the second process can be bound to the first socket, so that when interacting with data from the second process, the proxy thread corresponding to the second process can use the first socket for data transmission and reception.

In some embodiments, the first socket can exist in the proxy thread corresponding to the second process.

In some embodiments, the communication process based on Websocket is similar to the communication process based on TCP. The to-be-processed data is sent to a proxy thread corresponding to the second process, to enable the proxy thread corresponding to the second process to send the to-be-processed data to the second process based on the first socket.

In some embodiments, as shown in FIG. 5, when the first process needs to send data to a process (such as the second process), it determines whether there is a socket corresponding to the process from a socket maintenance list, that is, a Websocket list. If there is a socket corresponding to the process, there is no need to create a proxy thread and a socket corresponding to the process, and data is sent based on a proxy thread and a socket corresponding to the process.

Correspondingly, when communications are performed based on the Websocket communication manner, the second process also creates a socket corresponding to the connection when sending a Websocket connection, to obtain a fifth socket, and creates a proxy thread corresponding to the connection. The proxy thread is configured to serve as a proxy for related business during communications with the first process, that is, the proxy thread can receive the to-be-processed data through the fifth socket.

In this embodiment, the Websocket communication manner utilizes the Websocket protocol based on the TCP protocol, which can send or receive information in both directions, inheriting the advantages of the TCP communication manner. Websocket is generally used for data interaction between web pages and servers, therefore, when the communication between the first process and the second process is between a web page and a server, the Websocket communication manner can be selected as the communication manner between the first process and the second process.

In some embodiment, when communications are performed based on the UDP communication manner, the first process and the second process do not need to establish a connection, and the first target proxy thread is a universal proxy thread corresponding to UDP communication manner. The universal proxy thread is configured to serve as a proxy for the data sending service when the first process communicates with other processes based on the UDP communication manner. That is, the first process can use the universal proxy thread to send data to other processes, in order to improve processing performance.

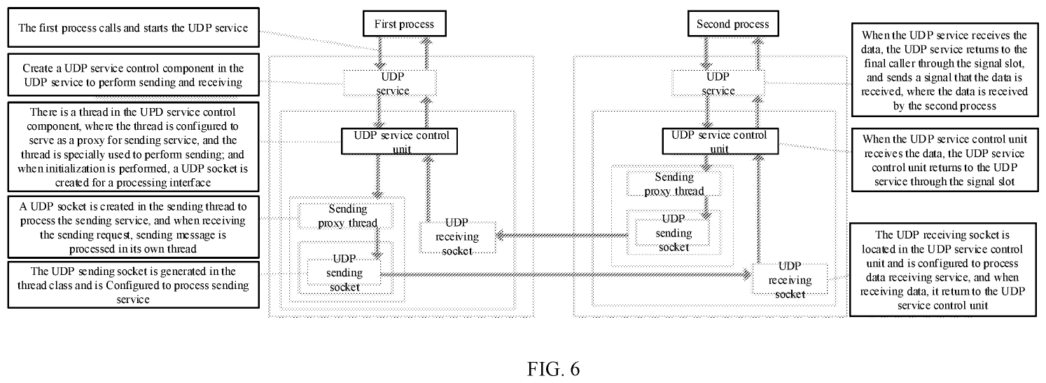

In some embodiments, to ensure simultaneous data transmission and reception, as shown in FIG. 6, two sockets are created, namely a second socket (i.e., a UDP sending socket) and a third socket (i.e., a UDP receiving socket). The second socket is used to send data, and the third socket is used to receive data. The second socket can be located separately within the universal proxy thread. Correspondingly, the UDP communication manner indicates the second socket and the third socket.

In some embodiment, when communication with the second process are performed based on the UDP communication manner, the to-be-processed data is sent to the universal proxy thread, so that the universal proxy thread can send the to-be-processed data to the second process based on the second socket, that is, the universal proxy thread sends the to-be-processed data to the second process through the second socket.

In some embodiments, the first process can receive first data sent by other processes based on the third socket to ensure simultaneous transmission and reception of data.

In this embodiment, the UDP communication manner is implemented based on the characteristics of UDP. There is no need to establish a connection before communication, and a multi-thread mechanism is adopted for communication, which can improve communication speed, i.e., communication efficiency. Two sockets are utilized to achieve simultaneous data transmission and reception. Therefore, when the requirements for communication speed are relatively high, and the requirements for communication reliability are relatively low, the UDP communication can be used for communications between processes.

In some embodiments, communications between non-local processes can further be achieved based on a message-queue communication manner. When communications are performed based on the message-queue communication manner, in response to determining that a target message queue is not full, a production function address is obtained. Based on the production function address, a corresponding production function is called to write the to-be-processed data to the target message queue, enabling the second process to read the to-be-processed data from the target message queue. The production function indicates the write operation of the to-be-processed data.

For example, the first process determines whether the target message queue (i.e., a buffer corresponding to the target message queue) is full when writing data. If the target message queue is full, indicating that data cannot be written to the buffer corresponding to the target message queue, the consumer is awakened to consume the data in the target message queue. If the target message queue is not full, indicating that data can be written to the target message queue, based on the production function address, the production function is called from a corresponding location to use the production function to write the to-be-processed data to the target message queue. After data is written, the second process is awakened, to consume the to-be-processed data from the target message queue.

When the target message queue is accessed, for example, when the to-be-processed data is written, the target message queue is locked, and after the write is completed, the target message queue can be unlocked, to prevent other processes from accessing the target message queue when the to-be-processed data is written, thus effectively avoiding other processes from writing simultaneously.

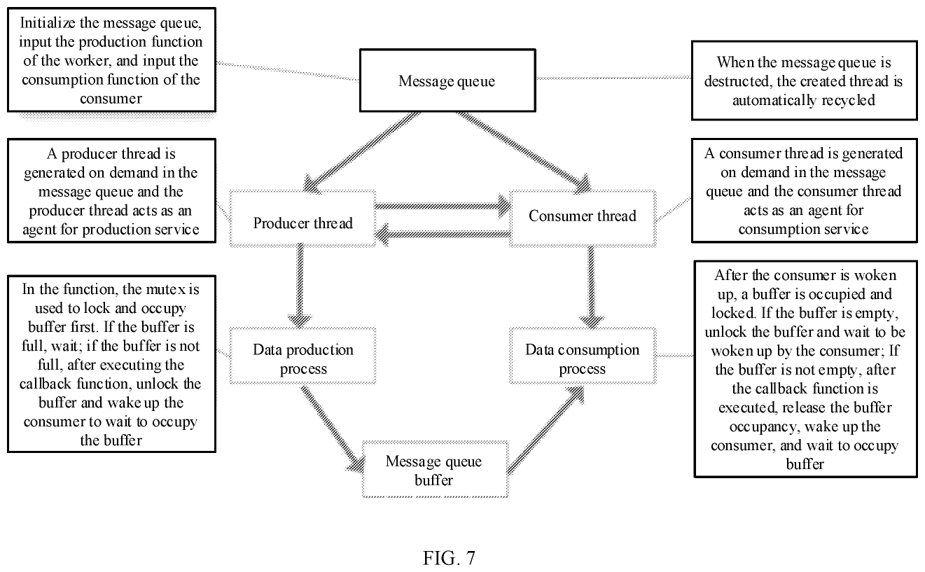

In some embodiments, as shown in FIG. 7, when the first process performs data writing, in order to improve the efficiency of data writing, a proxy thread can be used to write data, that is, a universal producer thread corresponding to the target message queue is created, so that the producer thread can serve as a proxy for production service. For example, the producer thread uses mutexes (mutual exclusions) to lock the target message queue. When the target message queue is full, waiting is performed. When the target message queue is not full, a callback function is executed, that is, the production function is called from a corresponding location based on the production function address, to write the to-be-processed data to the target message queue.

Correspondingly, as shown in FIG. 7, when the second process consumes data, in order to improve the efficiency of data consumption, a proxy thread can be used for data consumption. That is, a universal consumer thread corresponding to the target message queue is created, so that the consumer thread can serve as a proxy for consumption service. For example, the consumer thread uses mutexes to lock the target message queue. When the consumer thread is awakened, the target message queue is locked. When the target message queue is empty, the target message queue is unlocked and waiting is performed. When the target message queue is not empty, a callback function is executed, that is, based on a consumer function address, a consumer function is called from a corresponding location to consume corresponding data from the target message queue and send the data to corresponding process.

In some embodiments, when the first process fails to communicate with the second process based on the selected first communication manner, it can continue to select other communication manners for communication. For example, when communications with the second process based on the TCP communication manner fail, the Websocket communication manner can be selected as a new communication manner.

It can be understood that the operations performed by the first process mentioned above are actually performed by the first process using the processor in the first processing node where the first process is located. In addition, the relevant service names, thread names, interface names, and function names in the communication manners shown in FIGS. 4 to 7 are only examples, which is not limited in the present disclosure.

In this embodiment, the first communication manner provided in the present disclosure is applied to a Windows platform in the Qt environment, which has excellent compatibility characteristics, supports the expansion of C and CPP, and further has excellent performance in cross-platform characteristics, which can be ported to Linux systems.

In this embodiment, the production function indicates how to process the to-be-processed data and how to write the to-be-processed data to the target message queue. Since the production function is called based on the production function address, relevant personnel can flexibly set production data to meet actual needs. Similarly, the consumption function indicates how to consume data from the target message queue and the processing that needs to be performed on the obtained data. Since the consumption function is called based on the consumption function address, relevant personnel can flexibly set consumption data to meet actual needs.

In this embodiment, the message-queue communication manner is realized by mutexes and conditional waiting. According to relevant function addresses, the producer thread executes the production function, and the consumer thread executes the consumption function. When the target message queue is not empty, the consumer thread is awakened to consume data. When the target message queue is full, the producer thread stops working. When a message container has no data, the producer thread is awakened to work, that is, the producer thread writes data to the target message queue.

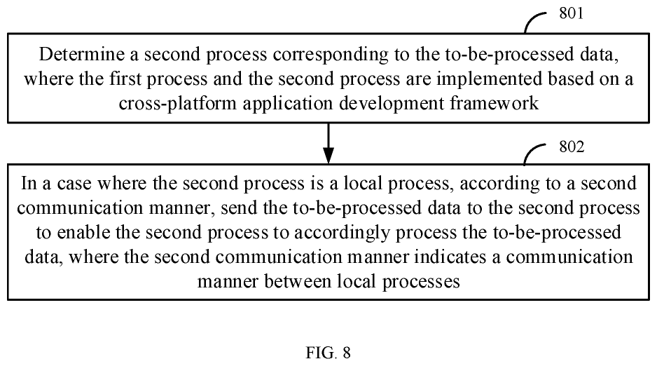

As shown in FIG. 8, a flowchart of a process communication method according to an embodiment of the present disclosure, the method is applied to a first processing node, where the first processing node includes at least one first process. The method includes the following steps S801 and S802.

In step S801, a second process corresponding to the to-be-processed data is determined. The first process and the second process are implemented based on a cross-platform application development framework.

In step S802, in a case where the second process is a local process, according to a second communication manner, the to-be-processed data is sent to the second process to enable the second process to accordingly process the to-be-processed data. The second communication manner indicates a communication manner between local processes.

In this embodiment, in a case where the second process is on the first processing node, it indicates that the second process is a local process, indicating that the first process and the second process are in the same computer, therefore, based on the first process and the second process, the suitable second communication manner is selected as a communication manner between the first process and the second process, that is, based on a communication manner between local processes, the to-be-processed data is sent to the second process, so that the processes implemented based on the cross-platform application development framework in the same computer can communicate, and a communication manner can be accurately selected.

In some embodiments, the second communication manner can be implemented based on a cross-platform application development framework, which supports all C and CPP platforms, and has good cross-platform characteristics.

In some embodiments, the second communication manner includes one or more of a handle communication manner, a named-pipe communication manner, a data bus communication manner and a shared-memory communication manner.

When a second communication manner is selected based on the first process and the second process, a second communication type is determined based on the first process and the second process. When the second communication type is a parent-child communication type, the anonymous-pipe communication manner is used as the second communication manner; and/or when the second communication type is a designated operating system communication type, the form communication manner is used as the second communication manner; and/or, when the second communication type is local connection communication type, the named-pipe communication manner is used as the second communication manner; and/or, when the second communication type is a bus communication type, the data bus communication manner is used as the second communication manner; and/or, when the second communication type is a memory communication type, the shared-memory communication manner is used as the second communication manner.

In some embodiments, when the second communication type is determined based on the first process and the second process, it can be determined through the following two ways.

In one way, an operating system of the first processing node is obtained, and in a case where the operating system of the first processing node is the designated operating system, it is determined that the second communication type is the designated operating system communication type; and/or, a process relationship between the first process and the second process is obtained, and in a case where the process relationship is a parent-child relationship, it is determined that the second communication type is a parent-child communication type; and/or, in a case where the first process and the second process are connected through a data bus, it is determined that the second communication type is the bus communication type.

In another way, the identifier of the first process and the identifier of the second process are obtained; a process communication type corresponding to the identifier of the first process and the identifier of the second process is determined (i.e., found) from a preset local process type mapping table and used as the second communication type.

For example, an identifier of a process can be determined based on the application program to which the process belongs or the node where the process is located. For example, the identifier of the first process is the identifier (such as the name) of the application program to which the first process belongs, and the identifier can also be pre-assigned, that is, identifiers corresponding to the application program to which the first processes belong are a certain identifier.

In this embodiment, when the second process and the first process are in the same computer, the handle communication manner can be used for communications between processes, that is, a handle of a target communication object is obtained, and based on the handle of the target communication object, the to-be-processed data is sent to the second process.

The handle communication manner includes an anonymous-pipe communication manner. Accordingly, the target communication object includes a first pipe indicated by the anonymous-pipe communication manner. The anonymous-pipe communication manner further indicates a second pipe, that is, there is a corresponding second pipe. The first pipe indicates data writing, and the second pipe indicates data reading. The first process and the second process are parent-child processes.

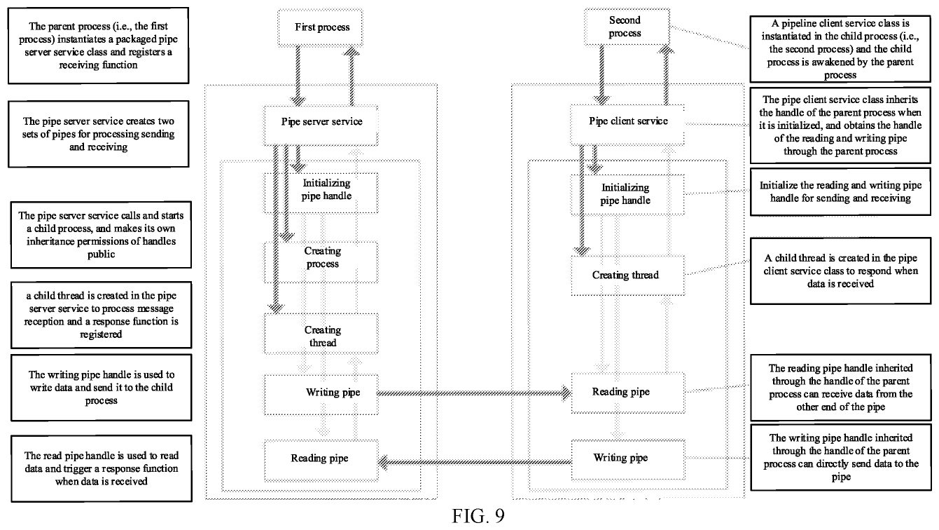

In this embodiment, since the anonymous-pipe can only carry out unidirectional communication, in order to achieve bidirectional communication, as shown in FIG. 9, the first process (i.e., the parent process) creates two pipes, namely, the first pipe (i.e., the write pipe) and the second pipe (i.e., the read pipe). When the first pipe and the second pipe are created, inheritance permissions of handles of the first pipe and the second pipe are made public, so that the child process, that is, the second process inherits the public handles of the parent process.

A standard input handle of the child process is set as a handle of the read pipe (i.e., the second pipe) obtained when the anonymous-pipe is created in the parent process, and a standard output handle of the child process is set as a handle of the write pipe (i.e., the first pipe) obtained when the anonymous-pipe is created in the parent process.

To improve processing performance, a proxy thread corresponding to the first pipe is created to serve as a proxy for related services (such as data writing services) in the first pipe, and a proxy thread corresponding to the second pipe is created to serve as a proxy for related services (such as data reading services) in the second pipe.

In some embodiments, when data is sent based on the anonymous-pipe communication manner, the proxy thread corresponding to the first pipe is determined. The proxy thread corresponding to the first pipe is configured to serve as a proxy for a data writing service corresponding to the first pipe. The to-be-processed data is sent to the proxy thread corresponding to the first pipe, to enable the proxy thread corresponding to the first pipe to write the to-be-processed data to the first pipe based on the handle of the first pipe, enabling the second process to read the to-be-processed data from the first pipe.

For example, when data is sent, it is necessary to use the write pipe, which is the first pipe. The proxy thread corresponding to the first pipe is determined, and the to-be-processed data is sent to the proxy thread corresponding to the first pipe. The proxy thread obtains the handle of the first pipe, finds the first pipe through the handle of the first pipe, and writes the to-be-processed data to the first pipe. The proxy thread corresponding to the first pipe created by the second process determines the handle of the first pipe, and reads the to-be-processed data from the first pipe using the handle of the first pipe.

In some embodiments, the second pipe can be used for data reading, that is, the second pipe receives second data sent by the proxy thread corresponding to the second pipe. The second data is data that is written by other processes and read from the second pipe based on a handle of the second pipe by the proxy thread corresponding to the second pipe. The proxy thread corresponding to the second pipe is configured to serve as a proxy for the data reading service corresponding to the second pipe.

For example, after other processes or proxy threads corresponding to the second pipe created by other processes write data in the second pipe, the proxy thread corresponding to the second pipe created by the first process reads data from the second pipe through the handle of the second pipe.

It can be understood that when the second process reads data from the first pipe, as shown in FIG. 9, the second process reads through its own read pipe (i.e., a third pipe). The handle of the read pipe is the handle of the first pipe, and the other end of the read pipe is the first pipe, i.e., the write pipe of the first process. In addition, the second process can further write data into its own write pipe. The handle of the write pipe is the handle of the second pipe, and the other end of the write pipe is the second pipe.

In some embodiments, in order to achieve timely data reading, relevant functions (such as slot functions) can be registered so that the second process can read data from the first pipe in time, and the second process can read data from the second pipe in time, which achieves synchronous/asynchronous invocation/response to messages.

In this embodiment, when the first process and the second process are local processes on the Windows system and are parent-child processes, the anonymous-pipe communication manner can be used for communication.

In some embodiments, the handle communication manner further includes the form communication manner. Correspondingly, the target communication object includes a form of the second process. The form communication manner includes WM_COPYDATA message communication manner.

Correspondingly, when the to-be-processed data is sent to the second process based on the form communication manner, a form name of the second process is obtained, and a form handle of the second process corresponding to the form name is determined. Based on the form handle, the to-be-processed data is sent to the form of the second process. After the to-be-processed data is received, the second process determines whether the to-be-processed data is the required data, that is, whether the type of the to-be-processed data is a target type. If so, relevant processing is performed on the to-be-processed data.

The second process can use pre-bound slot functions, or use relevant processing functions, to determine whether the to-be-processed data is the required data.

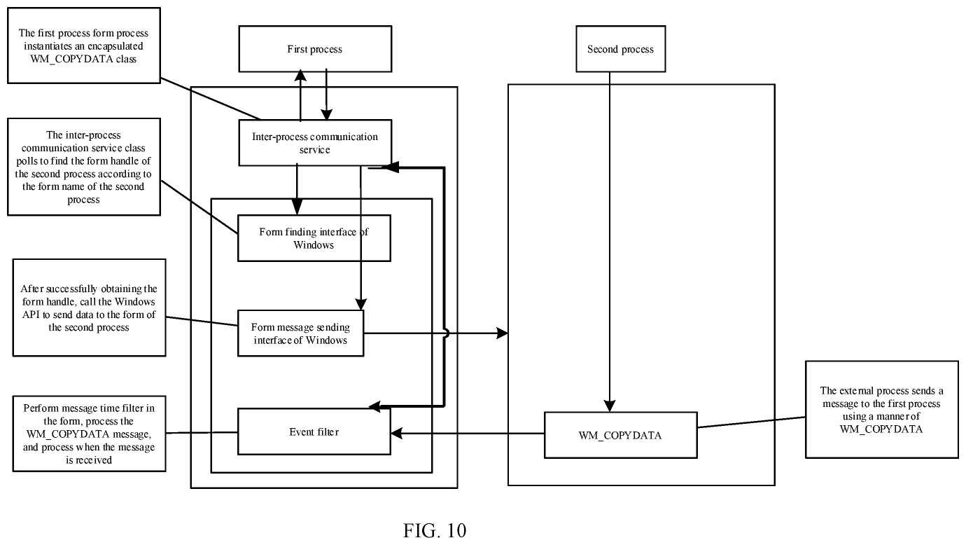

For example, as shown in FIG. 10, polling is performed based on the form name of the second process to find the form handle of the second process. A relevant API interface of the Windows system is called, and the to-be-processed data is sent to the form corresponding to the form handle of the second process, that is, the form of the second process.

In this embodiment, when communications are performed based on the form communication manner, there is no need to start the server, i.e., a local service. Instead, it is only required that the form handle of the second process is obtained, and a message is sent to the form handle, which has fast communication speed. Since the form communication manner requires the use of the relevant API interface of the Windows system, when the first process and the second process are local processes on the Windows system, the form communication manner can be selected for communication.

In some embodiments, the second communication manner includes the named-pipe communication manner. Correspondingly, according to the named-pipe communication manner, a local socket corresponding to the second process is obtained, where the local socket corresponding to the second process is created when the second process is connected to a named pipe created by the first process. Based on the local socket corresponding to the second process, the to-be-processed data is sent to the second process.

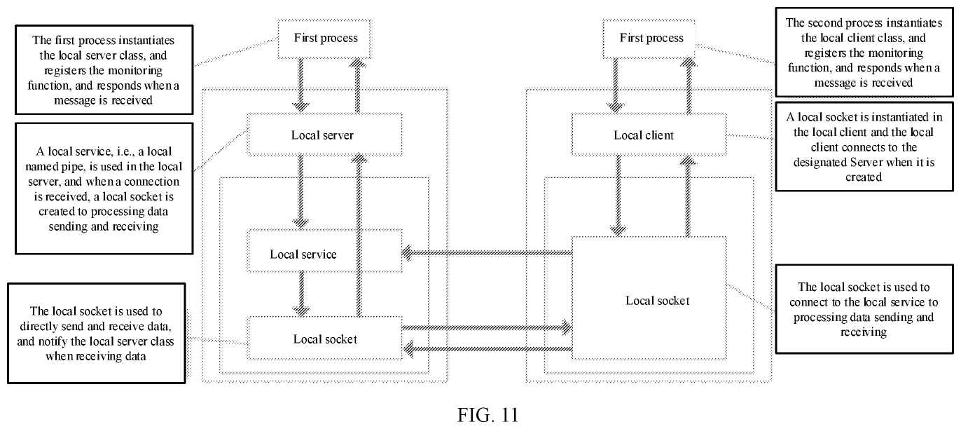

For example, as shown in FIG. 11, the first process starts a local named pipe, namely, a named pipe, i.e., Local Server. When the second process needs to communicate with the first process, the named-pipe service is connected. When the first process receives a connection, the first process creates a corresponding local socket (i.e., LocalSocket) to obtain the second process, i.e., the local socket corresponding to the connection. The first process writes the to-be-processed data to the second process through the local socket, and the second process receives the to-be-processed data through the created local socket corresponding to the connection.

In this embodiment, the named-pipe communication manner is implemented by using the LocalSocket encapsulated inside Qt, so that the named-pipe communication manner can be applied to multiple system platforms to achieve cross-platform, and multiple connections can be made. Before other processes communicate with the first process, the first process needs to start the LocalServer, that is, a local named pipe. Other processes can communicate by connecting to the LocalServer using the LocalSocket. The communication process of the named-pipe communication manner is similar to the communication process of TCP communication.

In some embodiments, when the first process needs to communicate with multiple local processes simultaneously, the named-pipe communication manner can be selected for communication.

In some embodiments, to ensure timely data reading, the first process and the second process monitor the local socket to obtain data in time when the data is monitored.

In some embodiments, in order to improve processing performance, when communications are performed in the named-pipe communication manner, a multi-thread mechanism can further be used. When a new connection is received, a proxy thread corresponding to the new connection is created to utilize the proxy thread for data transmission and reception. For example, when the second process connects to LocalServer, i.e., a local service, a proxy thread corresponding to the second process is created to serve as a proxy for related communication services using the proxy thread corresponding to the second process.

In some embodiments, the second communication manner includes the data-bus communication manner, i.e., the DBus communication manner. Correspondingly, when communications are performed with the second process based on the data-bus communication manner, the to-be-processed data is written to a target data bus to enable a data bus service corresponding to the target data bus to determine a response function bound to the to-be-processed data; and when the second process is bound to the response function, the to-be-processed data is sent to the second process.

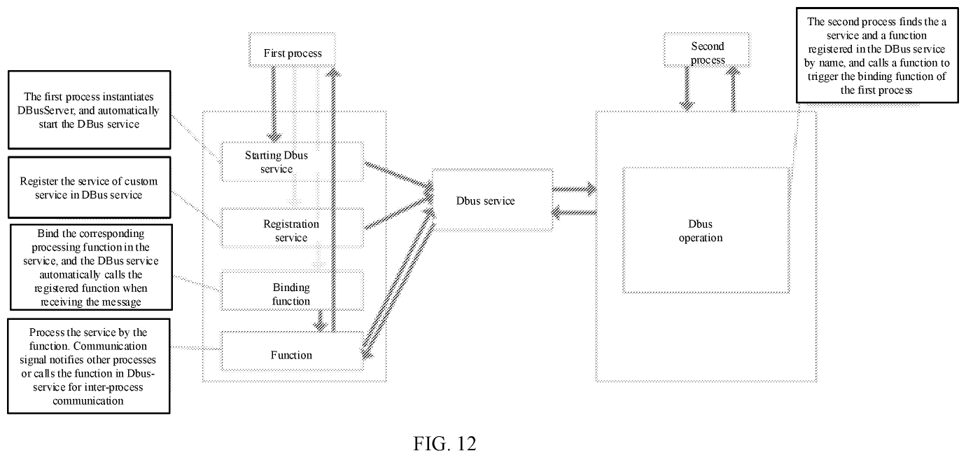

For example, as shown in FIG. 12, a relevant DBus-API interface is called to generate a data bus service, that is, a DBus service. The first process and the second process register their own message services and bound processing functions (such as response functions) on the data bus service. The first process writes the to-be-processed data to the target data bus. When the data bus service determines that the to-be-processed data needs to access the processing function registered by the second process, indicating the existence of a response function bound to the to-be-processed data, the to-be-processed data is sent to the second process to process the data based on the response function.

In some embodiments, when determining whether the to-be-processed data needs to access a processing function registered by the second process, the data bus service can determine based on a relevant identification in the to-be-processed data or other ways. For example, when the first process sends the to-be-processed data, a relevant signal is generated, and when the data bus service detects that the signal is a designated signal, the data bus service determines that the to-be-processed data needs to access the processing function registered by the second process.

In this embodiment, the data-bus communication manner can apply a signal slot mechanism, and a signal function can be directly connected to a slot function registered on the DBus service, and function blocking, i.e., synchronous calling, can be used to synchronously call functions on the data bus, such that a return result is obtained, furthermore, an asynchronous call function (non-signal-slot mode) is provided to obtain a return value of a function on the data bus, which has rich and excellent scalability.

In some embodiments, the second communication manner includes the shared-memory communication manner. Accordingly, when the to-be-processed data is sent to the second process according to the shared-memory communication manner, an idle shared-memory region is determined. The idle shared-memory region is locked, the to-be-processed data is written into the idle shared-memory region, and the idle shared-memory region is unlocked, to enable the second process to read the to-be-processed data from the idle shared-memory region.

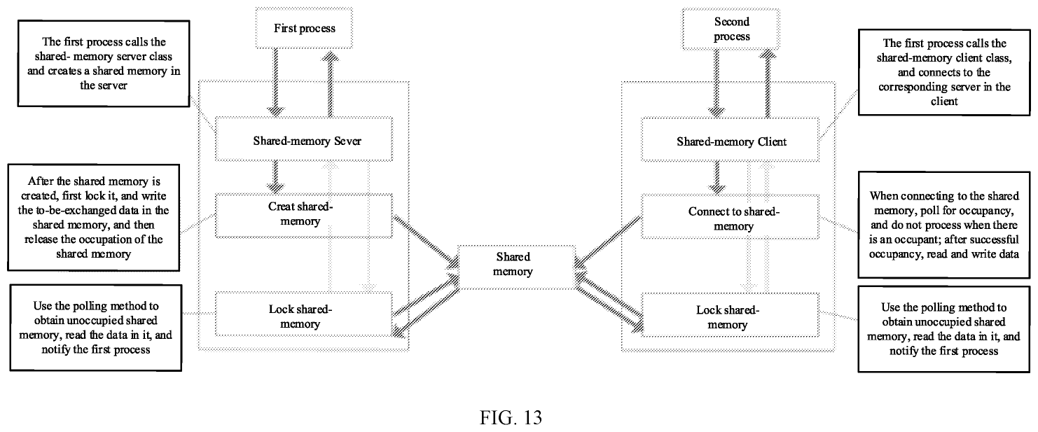

For example, as shown in FIG. 13, the first process creates a shared memory. When data writing is performed, polling is used to find the idle shared-memory region, that is, the unoccupied shared-memory region. The idle shared-memory region is locked to prevent other processes from writing data, and the to-be-processed data is written to the idle shared-memory region. After the writing is completed, the idle shared-memory region is unlocked, so that the second process can read the to-be-processed data from the idle shared-memory region.

For example, when the second process reads data, the second process polls the shared memory to determine the unoccupied shared-memory region. The data is read from the unoccupied shared-memory region, and after the data reading is completed, the first process is informed.

In this embodiment, when communication is performed based on the shared-memory communication manner, a shared memory is created, and data is shared by occupying and releasing the shared memory. When the first process occupies the shared memory, the first process writes data to the shared memory. After the shared memory is released, the second process occupies the shared memory and reads data. After the data reading is completed, the occupation of the shared memory is ended to achieve fast data writing and reading. However, since the shared-memory communication manner is to occupy the shared memory, other processes cannot receive a signal of data processing completion after processing is completed, and can only use the polling mode, so the communication efficiency is relatively low. Correspondingly, when the first process and the second process are local processes with low requirements for communication efficiency, the shared memory can be used for communication.

In this embodiment, the shared-memory communication manner uses semi-automatic memory management of Qt and an object generation mode based on an object tree to optimize the application and release of the memory and improve the process running robustness.

In some embodiments, when the form communication manner, the shared-memory communication manner, and the data-bus communication manner are used for communications between processes, the multi-thread mechanism can further be used, that is, a corresponding proxy thread is created, and the proxy thread is used to serve as a proxy for communication services to improve communication efficiency.

In some embodiments, the second communication manner includes the multi-thread communication manner and/or the message-queue communication manner, that is, when communications are performed between local processes, the multi-thread communication manner and the message-queue communication manner can also be used for communication.

In some embodiments, the second communication manner can further include a system pasting board communication manner, that is, the first process writes the to-be-processed data to a pasting board, and the second process achieves communication between the two processes by accessing the to-be-processed data on the pasting board.

In some embodiments, when different computers are connected through the data bus, processes in different computers can further communicate through the data-bus communication manner, that is, the first communication manner can further include the data-bus communication manner.

In some embodiments, the first communication manner can further include the shared-memory communication manner, that is, the first process and the second process use proxy nodes for shared-memory communication between non-local processes.

In some embodiments, QByteArray can further be used to store raw byte data (such as the to-be-processed data), which provides good protection during data serialization and deserialization, avoiding garbled code. That is, data in any format can be converted into data in QByteArray format, which has good data compatibility.

In some embodiments, when the first process fails to communicate with the second process based on the selected second communication manner, it can continue to select other communication manners for communication.

It can be understood that the operations performed by the first process mentioned above are actually performed by the first process using the processor on the first processing node where the first process is located. In addition, the relevant service names, thread names, interface names, and function names in the communication manners shown in FIGS. 9 to 13 are only examples, which is not limited in the present disclosure.

In some embodiments, the second communication manner can further include the multi-thread communication manner and message-queue communication manner.

In this embodiment, the second communication manner provided in the present disclosure is applied to a Windows platform in the Qt environment, which has excellent compatibility characteristics, supports the expansion of C and CPP, and further has excellent performance in cross-platform characteristics. Except for the form communication manner that cannot be reused on other platforms, other communication manners can be ported to the Linux system.

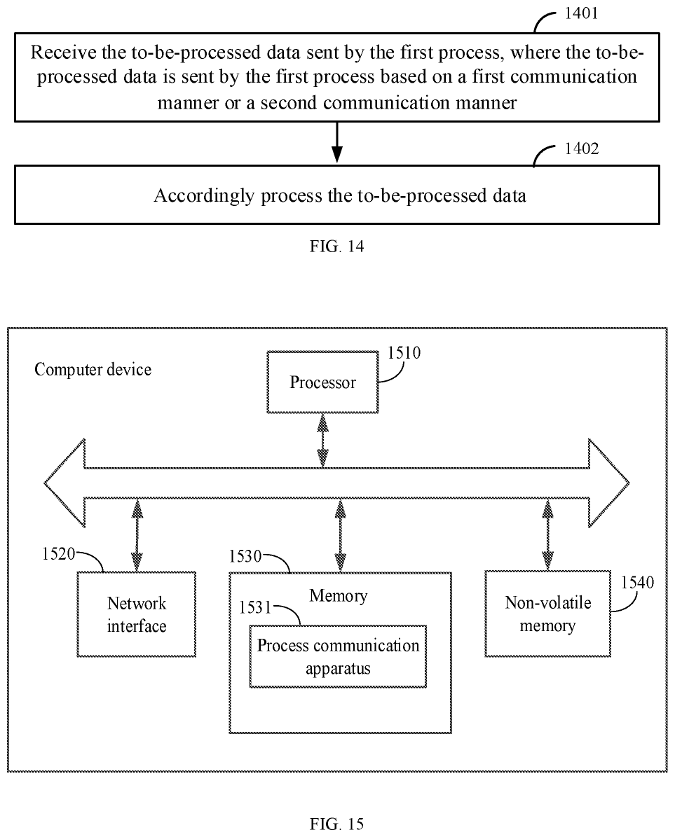

As shown in FIG. 14, a flowchart of a process communication method according to an embodiment of the present disclosure, the method is applied to a second processing node for data processing through at least one second process. The method includes the following steps S1401 and S1402.

In step S1401, the to-be-processed data sent by the first process is received. The to-be-processed data is sent by the first process based on a first communication manner or a second communication manner.

In step S1402, the to-be-processed data is accordingly processed.

In this embodiment, the second process receives the to-be-processed data sent by the first process through the first communication manner or the second communication manner, and performs related processing on the to-be-processed data, such as executing corresponding service operations.

For example, the communication manner used by the second process to receive the to-be-processed data is the same as the communication manner used by the first process to send the to-be-processed data. For example, when the first process uses the TCP communication manner to send to-be-processed data, the second process receives the to-be-processed data based on the TCP communication manner.

The first process and the second process are Qt processes.

In some embodiments, in the case where the to-be-processed data is bound to a preset slot function, based on the preset slot function, corresponding processing is performed on the to-be-processed data.

For example, in order to achieve timely processing of data, the signal slot mechanism is applied to the first communication manner and/or the second communication manner, that is, when the to-be-processed data is bound to a relevant slot function, and when the second process receives the to-be-processed data based on a certain communication manner, where the to-be-processed data is equivalent to a signal, a corresponding slot function is automatically triggered to process the to-be-processed data in time.

In some embodiments, when the first process sends data based on the message-queue communication manner, the second process also receives the to-be-processed data sent by the first process based on the message-queue communication manner, that is, obtains the consumption function address. Based on the consumption function address, a corresponding consumption function is called to read the to-be-processed data from the target message queue. The consumption function indicates a read operation on the to-be-processed data.

In some embodiments, to ensure the effectiveness of data reading, when data is consumed from the message queue, the target message queue is locked. After the target message queue is locked, in response to determining that the target message queue is not empty, the consumption function address is obtained to avoid invalid data consumption.

In some embodiments, the second process can further use a multi-thread mechanism to obtain to-be-processed data. For example, when the connection communication manner is used for communication, the second target proxy thread serves as a proxy for the communication service between the second process and the first process, and the second target proxy thread receives the to-be-processed data sent by the first process through a relevant socket and sends the data to the second process.

In some embodiments, the process of the second process using the first communication manner or the second communication manner to obtain the to-be-processed data is similar to the process of the first process using the first communication manner or the second communication manner to send the to-be-processed data. For example, when the first process uses a multi-thread mechanism to send data, the second process can also use a multi-thread mechanism to receive data.

It can be understood that the operations performed by the second process mentioned above are actually performed by the second process using the processor on the processing node where the second process is located.

In this embodiment, the first communication manner and the second communication manner use the signal slot mechanism unique to the Meta Object System. In order to facilitate the use of signal slots, an external signal slot interface is packaged and provided in the interface packaging to ensure good interactivity. Implementation relying on the observer mode of the signal slot, the packaged objects and their derived objects have an efficient communication interface, which are convenient for use.

In this embodiment, when the second process and the first process are both processes in the same computer, the first communication manner is used for communication, and when the second process and the first process are processes in different computers, the second communication manner is used for communication, which achieves accurate and flexible selection of communication manners and achieves communication between Qt processes.

Corresponding to the embodiments of the aforementioned methods, this present disclosure further provides embodiments of process communication apparatuses and their applied computer devices.

The embodiments of the process communication apparatuses in the present disclosure can be applied to computer devices, such as computers, servers, etc. The apparatus embodiments can be realized by software, hardware or a combination of software and hardware. Taking software implementation as an example, as an apparatus in a logical sense, it is formed by reading the corresponding computer program instructions in the non-volatile memory into the memory for operation by the processor where the apparatus is located. From a hardware perspective, as shown in FIG. 15, a hardware structure diagram of a computer device where a process communication apparatus of the present disclosure is located, in addition to the processor 1510, memory 1530, network interface 1520, and non-volatile memory 1540 shown in FIG. 15, the computer device where a process communication apparatus 1531 in the embodiments is located can usually include other hardware based on actual functions of the computer device, which is not repeated.

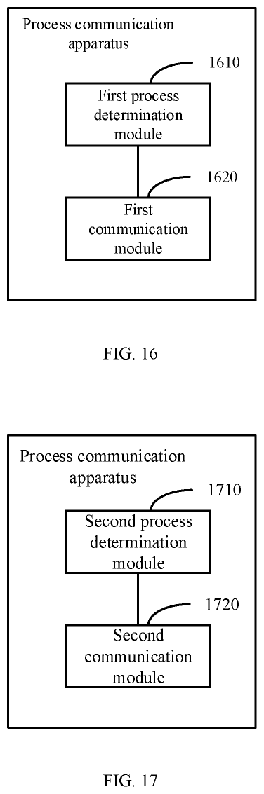

As shown in FIG. 16, a block diagram of a process communication apparatus according to an embodiment of the present disclosure, the apparatus is applied to a first processing node for data processing through at least one first process, and includes:

a first process determination module 1610, configured to determine a second process corresponding to to-be-processed data. The first process and the second process are implemented based on a cross-platform application development framework.

a first communication module 1620, configured to, in a case where the second process is not on the first processing node, according to a first communication manner, send the to-be-processed data to the second process to enable the second process to accordingly process the to-be-processed data. The first communication manner indicates a communication manner between non-local processes.

In some embodiments, the first communication module 1620 is configured to:
determine the first target proxy thread, where the first target proxy thread is configured to serve as a proxy for a communication service between the first process and the second process; and
send the to-be-processed data to the first target proxy thread, to enable the first target proxy thread to send the to-be-processed data to the second process.

In some embodiments, the first target proxy thread is a proxy thread corresponding to the second process, and is created in a case that a connection between the second process and the first process is established. The first target proxy thread indicates a first socket corresponding to the second process.

The first communication module 1620 is further configured to:
send the to-be-processed data to a proxy thread corresponding to the second process, to enable the proxy thread corresponding to the second process to send the to-be-processed data to the second process based on the first socket.

In some embodiments, the first communication module 1620 is further configured to:
start the transmission control protocol (TCP) service, and create the first socket corresponding to the second process when the second process connects to the TCP service; or when the full-duplex communication protocol Websocket connection request sent by the second process is received, create the first socket corresponding to the second process; and
based on the first socket, create a proxy thread corresponding to the second process.

In some embodiment, the first communication manner includes the UDP communication manner, and the first target proxy thread is a general proxy thread corresponding to the UDP communication manner. The universal proxy thread is configured to serve as a proxy for the data sending service when the first process communicates with other processes based on the UDP communication manner. The UDP communication manner indicates the second socket. The second socket is used to send data.

The first communication module 1620 is configured to:
send the to-be-processed data to the universal proxy thread, to enable the universal proxy thread to send the to-be-processed data to the second process based on the second socket.

In some embodiments, the UDP communication manner further indicates a third socket. The third socket is used to receive data.

The first communication module 1620 is further configured to:
based on the third socket, receive first data sent by other processes.

In some embodiments, the first communication module 1620 is configured to:
in response to determining that a target message queue is not full, obtain a production function address; and
based on the production function address, call a corresponding production function to write the to-be-processed data to the target message queue, enabling the second process to read the to-be-processed data from the target message queue. The production function indicates the write operation of the to-be-processed data.

In some embodiments, the first communication module 1620 is further configured to: lock the target message queue.

As shown in FIG. 17, a block diagram of a process communication apparatus according to an embodiment of the present disclosure, the apparatus is applied to a first processing node for data processing through at least one first process, and includes:
a second process determination module 1710, configured to determine a second process corresponding to to-be-processed data, where the first process and the second process are implemented based on a cross-platform application development framework; and
a second communication module 1720, configured to, in a case where the second process is on the first processing node, according to a second communication manner, send the to-be-processed data to the second process to enable the second process to accordingly process the to-be-processed data. The second communication manner indicates a communication manner between local processes.

In some embodiments, the second communication module 1720 is configured to:
obtain a handle of a target communication object, and based on the handle of the target communication object, send the to-be-processed data to the second process.

In some embodiments, the second communication manner includes the anonymous-pipe communication manner. The target communication object includes a first pipe indicated by the anonymous-pipe communication manner. The first pipe is used for data writing. The first process and the second process are parent-child processes.

The second communication module 1720 is further configured to:
determine a proxy thread corresponding to the first pipe, where the proxy thread corresponding to the first pipe is configured to serve as a proxy for a data writing service corresponding to the first pipe; and
send the to-be-processed data to the proxy thread corresponding to the first pipe, to enable the proxy thread corresponding to the first pipe to write the to-be-processed data to the first pipe based on the handle of the first pipe, enabling the second process to read the to-be-processed data from the first pipe.

In some embodiments, the anonymous-pipe communication manner further indicates a second pipe. The second pipe is used for data reading.

The second communication module 1720 is further configured to:
receive second data sent by the proxy thread corresponding to the second pipe. The second data is data that is written by other processes and read from the second pipe based on a handle of the second pipe by the proxy thread corresponding to the second pipe. The proxy thread corresponding to the second pipe is configured to serve as a proxy for the data reading service corresponding to the second pipe.

In some embodiments, the target communication object includes a form of the second process.

The second communication module 1720 is further configured to:
obtain a form name of the second process, and determine a form handle of the second process corresponding to the form name; and
based on the form handle, send the to-be-processed data to the form of the second process.

In some embodiments, the second communication module 1720 is configured to:
obtain a local socket corresponding to the second process, where the local socket corresponding to the second process is created when the second process is connected to a named pipe created by the first process; and
based on the local socket corresponding to the second process, send the to-be-processed data to the second process.

In some embodiments, the second communication module 1720 is configured to:
write the to-be-processed data to a target data bus to enable a data bus service corresponding to the target data bus to determine a response function bound to the to-be-processed data; and when the second process is bound to the response function, send the to-be-processed data to the second process.

In some embodiments, the second communication module 1720 is configured to:
determine an idle shared-memory region; and
lock the idle shared-memory region, write the to-be-processed data into the idle shared-memory region, and unlock the idle shared-memory region, to enable the second process to read the to-be-processed data from the idle shared-memory region.

The implementation process of the functions and effects of each module in the above apparatus is detailed in the implementation process of the corresponding steps in the above method.

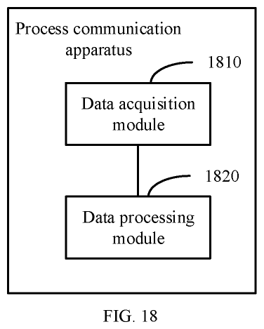

As shown in FIG. 18, a block diagram of a process communication apparatus according to an embodiment of the present disclosure, the apparatus is applied to a second processing node for data processing through at least one second process, and includes:
a data acquisition module 1810, configured to receive the to-be-processed data sent by the first process, where the to-be-processed data is sent by the first process based on a first communication manner or a second communication manner; and
a data processing module 1820, configured to perform corresponding processing on the to-be-processed data.

In some embodiments, the data processing module 1820 is configured to:
in the case where the to-be-processed data is bound to a preset slot function, based on the preset slot function, perform corresponding processing on the to-be-processed data.

In some embodiments, the data acquisition module 1810 is configured to:
obtain a consumption function address; and
based on the consumption function address, call a corresponding consumption function to read the to-be-processed data from the target message queue. The consumption function indicates a read operation on the to-be-processed data.

In some embodiments, the data acquisition module 1810 is further configured to:
lock the target message queue; and
in response to determining that the target message queue is not empty, obtain the consumption function address.

The implementation process of the functions and effects of each module in the above apparatus is detailed in the implementation process of the corresponding steps in the above method.

Correspondingly, the present disclosure further provides a computer device, which includes one or more processor; one or more memories, configured to store processor executable instructions; where the one or more processors are configured to:
determine a second process corresponding to to-be-processed data, where the first process and the second process are implemented based on a cross-platform application development framework; and
in a case where the second process is not on the first processing node, according to a first communication manner, send the to-be-processed data to the second process to enable the second process to accordingly process the to-be-processed data, where the first communication manner indicates a communication manner between non-local processes;
and/or,
in a case where the second process is on the first processing node, according to a second communication manner, send the to-be-processed data to the second process to enable the second process to accordingly process the to-be-processed data, where the second communication manner indicates a communication manner between local processes.
and/or,
receive to-be-processed data sent by a first process, where the to-be-processed data is sent by the first process based on a first communication manner or a second communication manner; and
perform corresponding processing on the to-be-processed data.

The embodiments of the present disclosure provides a computer-readable storage medium, where a computer program code is stored in the computer-readable storage medium, and the computer program code when executed by a processor achieves steps of the method according to any one of the above embodiments.

The embodiment of the present disclosure also provides a computer program product, including a computer program, where the computer program when executed by a processor achieves steps of the method according to any one of the above embodiments.

Since the apparatus embodiments basically corresponds to the method embodiments, the relevant parts can refer to the partial description of the method embodiments. The apparatus embodiments described above are only schematic, where the units described as separate components can be or cannot be physically separated, and the components shown as units can be or cannot be physical units, that is, they can be located in one place, or they can be distributed to multiple network units. Part or all of the modules may be selected according to actual requirements to implement the objectives of the solutions in the examples. A person skilled in the art can understand and implement without creative work.

It is to be noted that the relational terms such as “first” and “second” used herein are merely intended to distinguish one entity or operation from another entity or operation rather than to require or imply any such actual relation or order existing between these entities or operations. The term “including”, “containing” or any variation thereof is intended to encompass non-exclusive inclusion, so that a process, method, article or device including a series of elements includes not only those elements, but also other elements not listed explicitly or those elements inherent to such a process, method, article or device. Without further limitation, the element defined by the statement “including a . . . ” do not preclude the existence of additional identical elements in the process, method, article, or device that include the element.

The above provides a detailed introduction to the methods and apparatuses provided in the embodiments of the present disclosure. Specific examples are applied in the present disclosure to explain the principles and embodiments of the present disclosure. The explanations of the above embodiments are only used to help understand the methods and core ideas of the present disclosure. Meanwhile, for those skilled in the art, based on the idea of the present disclosure, there will be changes in the embodiments and application scopes. In summary, the content of the specification should not be construed as limiting the present disclosure.

1. A method, comprising:
determining a second process corresponding to data to be processed by a first process, wherein the first process and the second process are implemented based on a cross-platform application development framework; and
when the second process is not on a first processing node, according to a first communication manner, sending the data to the second process and enabling the second process to process the data, wherein the first communication manner indicates a communication manner between non-local processes;
when the second process is on the first processing node, according to a second communication manner, sending the to-be-processed data to the second process and enabling the second process to process the data, wherein the second communication manner indicates a communication manner between local processes.

2. The method according to claim 1, wherein according to the first communication manner, sending the data to the second process comprises:
determining a first target proxy thread, wherein the first target proxy thread is configured to serve as a proxy for a communication service between the first process and the second process; and
sending the data to the first target proxy thread, and enabling the first target proxy thread to send the data to the second process.

3. The method according to claim 2, wherein the first target proxy thread is a proxy thread corresponding to the second process, and is created in a case that a connection between the second process and the first process is established, wherein the first target proxy thread indicates a first socket corresponding to the second process; and
sending the data to the first target proxy thread and enabling the first target proxy thread to send the data to the second process comprises:
sending the data to a proxy thread corresponding to the second process, and enabling the proxy thread corresponding to the second process to send the data to the second process based on the first socket.

4. The method according to claim 3, further comprising:
starting a transmission control protocol (TCP) service, and when the second process connects to the TCP service, creating the first socket corresponding to the second process; or in response to receiving a protocol Websocket connection request for full duplex communication sent by the second process, creating a first socket corresponding to the second process; and
based on the first socket, creating a proxy thread corresponding to the second process.

5. The method according to claim 2, wherein the first communication manner comprises a user datagram protocol (UDP) communication manner, the first target proxy thread is a universal proxy thread corresponding to the UDP communication manner, the universal proxy thread is configured to serve as a proxy for a data transmission service when the first process communicates with other processes based on the UDP communication manner, the UDP communication manner indicates a second socket, and the second socket is configured to send data; and
sending the data to the first target proxy thread and enabling the first target proxy thread to send the data to the second process comprise:
sending the data to the universal proxy thread and enabling the universal proxy thread to send the data to the second process based on the second socket.

6. The method according to claim 5, wherein the UDP communication manner further indicates a third socket, wherein the third socket is configured to receive data; and the method further comprises:
based on the third socket, receiving first data sent by other processes.

7. The method according to claim 1, wherein according to the first communication manner, sending the data to the second process comprises:
in response to determining that a target message queue is not full, obtaining a production function address; and
based on the production function address, calling a corresponding production function to write the data to the target message queue, enabling the second process to read the data from the target message queue, wherein the production function indicates a write operation on the data.

8. The method according to claim 7, further comprising:
locking the target message queue.

9. (canceled)

10. The method according to claim 1, wherein according to the second communication manner, sending the data to the second process comprises:
obtaining a handle of a target communication object, and based on the handle of the target communication object, sending the data to the second process.

11. The method according to claim 10, wherein the second communication manner comprises anonymous-pipe communication manner, and the target communication object comprises a first pipe indicated by the anonymous-pipe communication manner, wherein the first pipe is configured for data writing, and the first process and the second process are parent-child processes; and
wherein based on the handle of the target communication object, sending the data to the second process comprises:
determining a proxy thread corresponding to the first pipe, wherein the proxy thread corresponding to the first pipe is configured to serve as a proxy for a data writing service corresponding to the first pipe; and
sending the data to the proxy thread corresponding to the first pipe enabling the proxy thread corresponding to the first pipe to write the data to the first pipe based on the handle of the first pipe, and enabling the second process to read the data from the first pipe.

12. The method according to claim 11, wherein the anonymous-pipe communication manner further indicates a second pipe, wherein the second pipe is configured for data reading; and wherein the method further comprises:
receiving second data sent by a proxy thread corresponding to the second pipe, wherein the second data is data that is written by other processes and read from the second pipe based on a handle of the second pipe by the proxy thread corresponding to the second pipe; and the proxy thread corresponding to the second pipe is configured to serve as a proxy for a data reading service corresponding to the second pipe.

13. The method according to claim 10, wherein the target communication object comprises a form of the second process; and
wherein based on the handle of the target communication object, sending the data to the second process comprises:
obtaining a form name of the second process, and determining a form handle of the second process corresponding to the form name; and
based on the form handle, sending the data to the form of the second process.

14. The method according to claim 1, wherein according to the second communication manner, sending the data to the second process comprises:
obtaining a local socket corresponding to the second process, wherein the local socket corresponding to the second process is created when the second process is connected to a named pipe created by the first process; and
based on the local socket corresponding to the second process, sending the data to the second process.

15. The method according to claim 1, wherein according to the second communication manner, sending the data to the second process comprises:
writing the data to a target data bus and enabling a data bus service corresponding to the target data bus to determine a response function bound to the data; and
when the second process is bound to the response function, sending the data to the second process.

16. The method according to claim 1, wherein according to the second communication manner, sending the data to the second process comprises:
determining an idle shared-memory region; and
locking the idle shared-memory region, writing the data into the idle shared-memory region, and unlocking the idle shared-memory region and enabling the second process to read the data from the idle shared-memory region.

17. A method, comprising:
receiving data sent by a first process, wherein the data is sent by the first process based on a first communication manner or a second communication manner; and
performing processing on the data.

18. The method according to claim 17, further comprising:
when the data is bound to a preset slot function, based on the preset slot function, performing processing on the data.

19. The method according to claim 17, wherein receiving the data sent by the first process comprises:
obtaining a consumption function address; and
based on the consumption function address, calling a corresponding consumption function to read the data from a target message queue, wherein the consumption function indicates a read operation on the data.

20. The method according to claim 19, further comprising:
locking the target message queue; and
in response to determining that the target message queue is not empty, obtaining the consumption function address.

21-23. (canceled)

24. A non-transitory computer-readable storage medium, wherein a computer program is stored in the non-transitory computer-readable storage medium, and the computer program when executed by a processor achieves a process communication method, comprising:
determining a second process corresponding to data to be processed by a first process, wherein the first process and the second process are implemented based on a cross-platform application development framework; and
when the second process is not on a first processing node, according to a first communication manner, sending the data to the second process and enabling the second process to process the data, wherein the first communication manner indicates a communication manner between non-local processes;
when the second process is on the first processing node, according to a second communication manner, sending the to-be-processed data to the second process and enabling the second process to process the data, wherein the second communication manner indicates a communication manner between local processes.

25. (canceled)
